(19) United States
(12) Patent Application Publication
(10) Pub. No.: US 2005/0271018 A1
(43) Pub. Date: Dec. 8, 2005

(54) System and method for assisting handoff between wide area and local area networks

(75) Inventors: Huitao Liu, Round Rock, TX (US); Feng Wang, Austin, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/860,591

(22) Filed: Jun. 3, 2004

(51) Int. Cl. H04Q 7/24

(52) U.S. Cl. 370/338

(57) ABSTRACT

A system and method are disclosed for assisting handoff between wide area and local area networks. A system incorporating teachings of the present disclosure may include, for example, a wireless local area network (WLAN) base station having a wireless local area transceiver and a wide area network module. In some embodiments, the wide area network module may include a wireless receiver. The system may also include a handoff engine. In operation, the handoff engine may use wireless wide area network (WWAN) access information received via the wide area network module and initiate outputting of a packet via the wireless local area transceiver that includes at least a portion of the WWAN access information.

### FIELD OF THE INVENTION

The present disclosure relates generally to wireless networking, and more specifically to a system and method for assisting handoff between wide area and local area networks.

### BACKGROUND

A deployed wireless local area network (WLAN) like an 802.11 (a)(b) or (g) network offers wireless communication services to devices located within a relatively small geographic area. A typical WLAN installation may provide an effective coverage footprint having a diameter of about one thousand feet or less.

Similarly, a deployed wireless wide area network (WWAN) like a global system for mobile (GSM) communication network also offers wireless communication services to devices within a coverage area. However, the coverage footprint of a WWAN may include a much larger geographic area having, for example, a diameter of a few miles.

In recent years, users have witnessed a broad deployment of both WLAN and WWAN networks. And, many device manufacturers have begun to market multi-mode terminal devices capable of accessing and communicating within both WLAN and WWAN networks. While these multi-mode devices provide users with more network interconnection options, the devices have several shortcomings.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 presents a block diagram of a communication system that incorporates teachings of the present disclosure;

FIG. 2 shows a flow diagram for a wireless call handoff technique that may be used to implement teachings of the present disclosure;

FIG. 3 presents a simplified block diagram for a system that incorporates teachings of the present disclosure to provide a user with a more seamless handoff between wireless networks; and

FIG. 4 shows a flow diagram for a technique that may be used to implement teachings of the present disclosure.

### DETAILED DESCRIPTION OF THE DRAWINGS

As wireless network deployments expand and the coverage areas of WLAN and WWAN networks become more overlapping, users of multi-mode terminal devices may seek a more efficient and seamless mechanism for WLAN/WWAN call handoffs. For example, an individual may be using a communication device to engage in an active browsing session or a Voice over Internet Protocol (VoIP) call. The individual's device may be communicating across a WLAN network like an 802.11 (a), (b) or (g) network. At some point during the communication, the individual may need to leave the relatively small coverage area of the WLAN network. In one embodiment, the individual's device may be capable of communicating with a WWAN network that has a coverage area overlapping the coverage area of the WLAN. To avoid dropping the active communication, the individual may need to transition to the WWAN network as seamlessly and efficiently as possible.

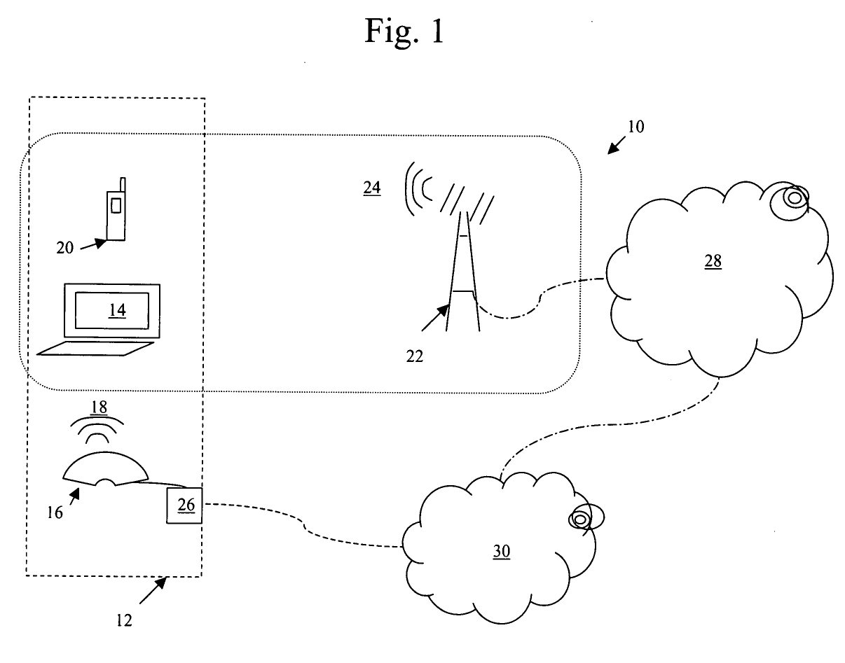

The present disclosure describes solutions for assisting handoff from wireless local area networks to wireless wide area networks. From a high level, a system and/or method incorporating teachings of the present disclosure may allow a wireless enabled device to move from WLAN to WWAN networks. In some embodiments, this movement may occur in a manner transparent to a given user. As mentioned above, FIG. 1 presents a block diagram of a communication system 10 that incorporates teachings of the present disclosure. As depicted, system 10 includes a WLAN footprint indicated at 12 that covers various wireless enabled computing devices accessible by a user or subscriber. The devices may include, for example, a laptop computer 14 and a wireless telephone 20. Each of these devices may possess an effective identifier, which could include an IP address, a telephone number, a media access control address, a data link control (DLC) address, and/or some other addressable identifier.

In the embodiment of FIG. 1, laptop 14 and wireless telephone 20 may both have a short-range or local area wireless transceiver that serves to connect the devices to LAN hub 16 across wireless link 18. As depicted, LAN hub 16 may communicate with one or more local devices across a wireless link. In some embodiments, LAN hub 16 may communicate across wired links as well. As depicted, LAN hub 16 may have EtherSwitch or router functionality and may utilize a backhaul at least partially provided by a service line data connection to a broadband network interface device like modem 26. Depending upon implementation detail, modem 26 may be configured to communicate digital VoIP data to an Internet protocol network like the public Internet. In a particular example, modem 26 may be an asynchronous digital subscriber line (ADSL) modem, a digital subscriber line (DSL) modem, a satellite modem, a fiber optic termination point, a cable modem, or other high-speed interface.

As depicted, hub 16 may act as a wireless local area network (WLAN) base station and may have both a wireless local area transceiver and a wide area network module. Hub 16 may also include a handoff facilitation engine capable of accessing wireless wide area network (WWAN) access information received through the wide area network module. The handoff facilitation engine may also initiate outputting of a packet via the wireless local area transceiver that includes at least a portion of the WWAN access information.

Depending upon implementation detail, hub 16 may include a housing component that at least partially defines an interior cavity. A mounting platform may be located within the interior cavity and may be securing the wide area network module and the wireless local area transceiver within the interior cavity.

Within system 10, laptop 14 and wireless phone 20 may also be capable of connecting to a cellular network node 22 across a wireless link 24, which may be, for example, GSM, General Packet Radio Service (GPRS), and Enhanced Data Rate for GSM Evolution (EDGE). Wireless links 18 and 24 may be implemented in several ways. The link type may depend on the electronic components associated with the given wireless devices and wireless network nodes. The wireless computing device and/or wireless hub (Wireless Enabled Devices) may include any of several different components. For example, a Wireless Enabled Device may have a wireless wide area transceiver, which may be part of a multi-device platform for communicating data using radio frequency (RF) technology across a large geographic area. This platform may for example, be a GPRS, EDGE, or UMTS platform, and may include multiple integrated circuit (IC) devices or a single IC device. Other WWAN technologies may also be deployed in system 10. For example, a service provider may elect to use a technology that complies with IS-136, IS-95, GSM, UMTS, CDMA1x, WiMax, 802.16, and/or some other appropriate WWAN protocols or communication standards.

A Wireless Enabled Device may also have a wireless local area transceiver that communicates using spread spectrum, Orthogonal Frequency Division Multiplexing (OFDM), or other radio technologies in a 2.4 GHz range, 5 GHz range, or other suitable range. The wireless local area transceiver may be part of a multi-device or single device platform and may facilitate communication of data using low-power RF technology across a small geographic area. For example, if the wireless local area transceiver includes a Bluetooth transceiver, the transceiver may have a communication range with an approximate radius of twenty-five to one hundred feet. If the wireless local area transceiver includes an 802.11 (x) transceiver, such as an 802.11(a)(b) or (g), the transceiver may have a communication range with an approximate radius of one hundred fifty to one thousand feet. Depending upon implementation detail, other WLAN technologies, like HiperLAN, may be deployed with system 10.

As shown in FIG. 1, LAN hub 16 may represent an 802.11(x) embodiment, which may in some cases be referred to as a hotspot or an access point. And, as mentioned above, LAN hub 16 may be communicatively coupled to modem 26, which may be capable of connecting hub 16 to a broader network, like Public Internet 28. As shown, both laptop 14 and wireless phone 20 may be capable of communicatively coupling with Public Internet 28. While located within footprint 12, either device may connect via link 18 to hub 16 and via modem 26 to a service provider network 30, which may facilitate connection to Public Internet 28. In some embodiments, network 30 may be a cable network, and modem 26 may include a cable modem. As depicted, network 30 may be a Public Switched Telephone Network (PSTN), and modem 26 may include an xDSL modem. While modem 26 and hub 16 are depicted as stand alone and discrete devices, they may also be combined into a single device.

In practice, the information communicated across the various links of system 10 may be compressed and/or encrypted prior to communication. Communication may be at least partially via a circuit-switched network like the PSTN, a frame-based network like Fibre Channel, or a packet-switched network that may communicate using Transmission Control Protocol/Internet Protocol (“TCP/IP”) packets like Internet 28. The physical medium making up at least some portion of the various links may be coaxial cable, fiber, twisted pair, an air interface, other, or a combination thereof. In some embodiments, network access links may provide a broadband connection facilitated by an xDSL modem, a cable modem, an 802.11x device, some other broadband wireless linking device, or a combination thereof. The broadband connection may include a link providing data rates greater than 56 Kbps. Other broadband connections may provide data rates greater than 144 Kbps, 256 Kbps, 500 Kbps, 1.0 Mbps, 1.4 Mbps, or faster.

In a preferred embodiment of system 10, a user may maintain a network connection to network 30 and may subscribe to a VoIP service. In operation of system 10, a subscriber may use telephone 20 to engage in a VoIP call. The call signals may be traveling across a WLAN supported by hub 16. If the subscriber moves to the edge of or outside footprint 12, the signal strength may become too low. In preferred embodiments, hub 16 may have earlier passed WWAN access parameters to telephone 20, and telephone 20 may use these parameters to seamlessly transition from the WLAN to the WWAN. Depending upon implementation details, the transition may occur without requiring telephone 20 to perform all of the typical WWAN service request procedures. The transition may also occur without dropping the active VoIP call between the telephone 20 and a remote device. The transition may occur automatically as the signal strength of the WLAN connection approaches a low threshold value and/or in response to an input by the subscriber.

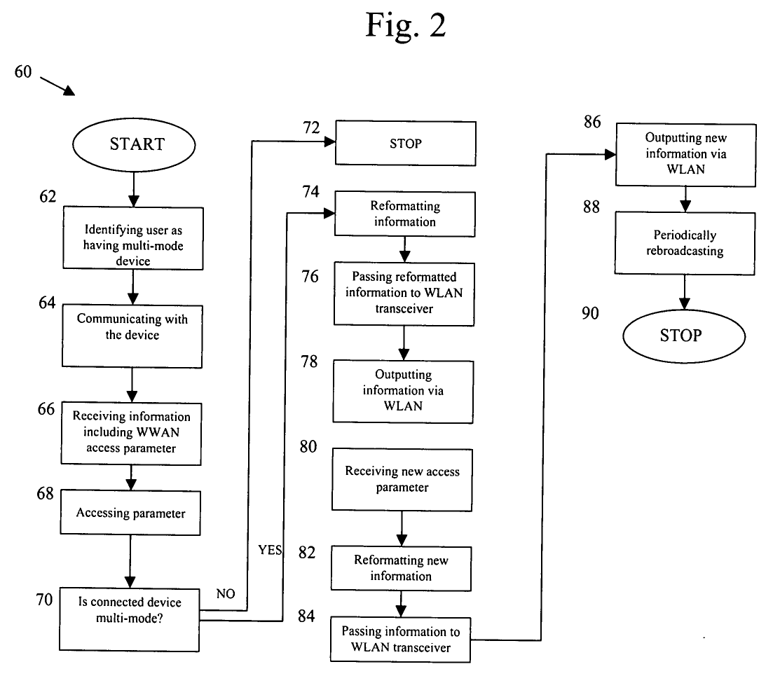

The operation of a system like system 10 may be better understood by reference to additional figures. As mentioned above, FIG. 2 shows a flow diagram for a technique 60 that may be used to implement teachings of the present disclosure. At step 62, a VoIP subscriber may be identified as someone utilizing a multi-mode terminal device. The subscriber may, at step 64, camp on a WLAN and communicate with a hub across the WLAN. The communication may, for example, be in connection with a VoIP call that the user is engaged in with a remote device. At step 64, the WLAN hub may receive a communication of information that includes WWAN access information and parameters. The information may be received wirelessly, for example, with a Wireless Wide Area receiver and/or transceiver associated with the hub. The information may also have been received via a wired connection. However received, access parameters contained in the communication may be accessed at step 68.

At step 70, the type of devices camped on the WLAN may be determined. If no multi-mode device is connected, technique 60 may progress to stop at step 72. If one or more multi-mode devices are connected, technique 60 may progress to step 74, at which point the information received may be reformatted into a packet appropriate for communication across the WLAN. At step 76, the reformatted information may be passed to a Wireless Local Area transceiver of the WLAN hub, and the information may be output at step 78. Depending upon implementation detail, the output information may be addressed to specific devices on the WLAN and/or broadcasted within a broadcast channel of the WLAN.

At step 80, new and/or additional WWAN access parameters may be received. The new parameters may be reformatted at step 82 and passed to a WLAN transceiver at step 84. In some cases, the new parameters may be associated with a specific wireless carrier and may only need to be communicated to multi-mode terminal devices that use that specific wireless carrier. In other cases, the new parameters may need to be broadly communicated. At step 86, a packet containing the new parameter information may be output across the WLAN and, at step 88, a given WLAN hub may periodically rebroadcast access parameter information across the WLAN.

Technique 60 may then progress to stop at step 90. Though technique 60 has been described as having a sequence of steps, additional steps may be added, steps may be removed, steps may be re-ordered, and/or looped, without departing from the teachings of the present disclosure.

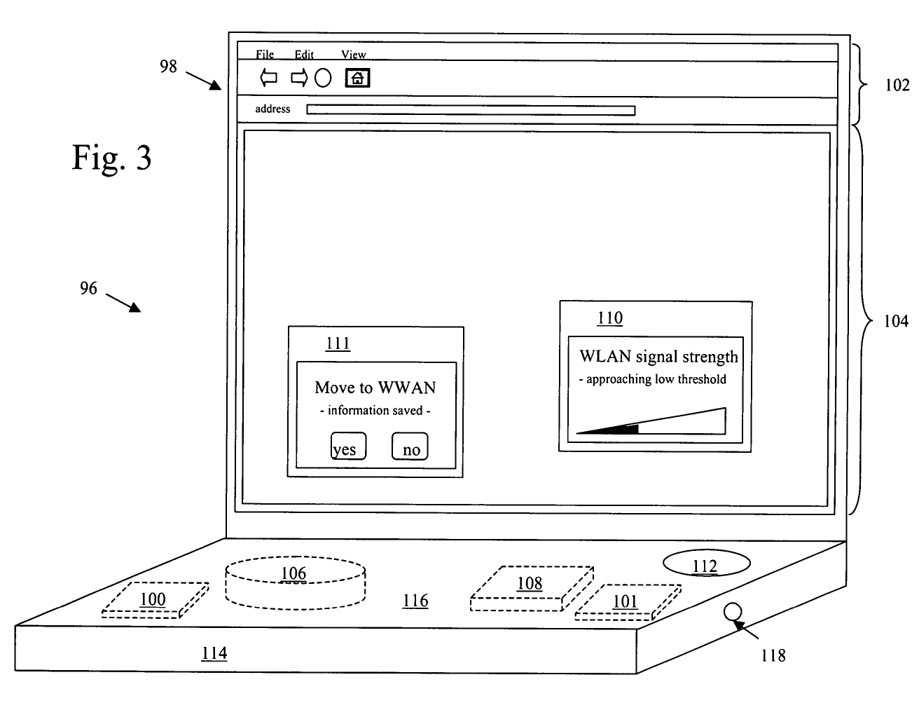

As mentioned above, FIG. 3 presents a simplified block diagram for a system 96 that incorporates teachings of the present disclosure to assist in WWAN/WLAN call handoffs. System 96 includes a laptop computer 98, which may be communicating across a WLAN interface using WLAN transceiver 100. Transceiver 100 may, for example, help connect laptop 98 to a Wi-Fi hub, which may in turn be communicatively coupled to a wired wide area network like the PSTN or a cable network. As depicted, laptop computer 98, may also be capable of communicating across a WWAN interface using WWAN transceiver 101. As such, laptop 98 and/or an application executing at laptop 98 may occasionally need to transition back and forth between a WLAN connected state and a WWAN connected state.

To facilitate this transition, laptop 98 may include a computing platform, a wireless local area network (WLAN) transceiver, and a wireless wide area network (WWAN) transceiver. As described below, laptop 98 may also include a housing component that at least partially defines an interior cavity. Depending on design detail, an interior surface of laptop 98 may maintain the computing platform, the WLAN transceiver, and the WWAN transceiver in respective locations within the interior cavity. In addition to the above, laptop 98 may also have a handoff engine operable to execute on the computing platform and to allow laptop 98 to process an access packet received via the WLAN transceiver. The access packet may contain access information that includes an access parameter for interacting with a node of a wide area wireless network WWAN. The handoff engine may allow laptop 98 to use the access parameter to transition from a WLAN connection to a WWAN connection.

A web browser application may be running on laptop 98 and may present a user of the laptop with a navigation window 102 and a display pane 104. In operation, a user may type a Uniform Resource Locator (URL) into a portion of navigation window 102 and a page having that URL may be communicated to laptop 98 and presented within display pane 104. When the laptop sends a request for the page having the input URL, a network element of the data network may recognize in the request an address to which it should send the page.

The presence and/or the associated signal strength of a network connection at least partially provided via transceiver 100 may be recognized by a component of laptop 98. For example, laptop 98 may include a computer-readable medium 106 storing computer-readable data. Execution of some part of this data by a processor like processor 108 may allow laptop 98 to track signal strength, to act as a VoIP softphone, and to seamlessly transition between different types of networks during an active VoIP call session.

Laptop 98 may also be capable of initiating presentation of GUI element 110 that may, as depicted, display WLAN signal information to the user. As shown, GUI element 110 may indicate to the user that the signal strength of the WLAN connection provided by transceiver 100 is waning and that the signal is approaching a lower end threshold. This information may let the user know that laptop 98 may soon transition to a WWAN connection via transceiver 101. As shown, another element, GUI element 111 may be active and may prompt the user to move to an available WWAN network. As indicated in GUI element 111, laptop 98 may already have the appropriate connection information for the available WWAN. Depending upon implementation detail, this connection information may have been received by laptop 98 via transceiver 100.

For example, a WLAN hub device communicating with laptop 98 via transceiver 100 may have passed sufficient WWAN connection information to laptop 98 while laptop 98 was camped on the WLAN. The connection information may include, for example, WWAN operator information, cell ID, channel number, Radio Frequency or Code information for a broadcast channel of CDMA network, channel description, access channel control parameters, neighbor cell information, measuring and reporting parameters, and/or other WWAN connection parameters.

In some embodiments, the user may be engaged in an active VoIP call via speaker and microphone assembly 112, which may be designed to interact with a housing component 114 of laptop 98. As depicted, housing component 114 may also at least partially form an interior cavity 116 that houses processor 108 and a memory like medium 106, which may be RAM, ROM, flash, and/or some other appropriate form of memory.

Though system 96 shows an integrated system where a single computer embodies a computer, a VoIP telephone, and a WWAN/WLAN handoff application, other form factors and designs may be employed to practice teachings of the present disclosure. Laptop 98 may be replaced with another multi-mode device like a Personal Digital Assistant (PDA), a smartphone, a wireless telephone, and/or some other appropriate device. Similarly, a system designer may elect to utilize stand alone or discrete modules that have their own housing to perform certain functions.

For example, a removable card, like a SIM or PCMCIA card, may engage with an electronic device to facilitate WLAN interconnection and WLAN/WWAN handoffs. Such a component may have a Universal Serial Bus (USB) interface capable of being plugged into a mating USB interface of the electronic device. Other interface designs may include, for example, an 802.11 (x) interface, a Bluetooth interface, a Type I, II, and/or III Personal Computer Memory Card International Association (PCMCIA) card and slot interface, some other memory card form factor interface, a Firewire interface, and/or an appropriate parallel bus interface. With such a design, a user may be able to “retrofit” an existing communication device to add desirable features like a WLAN/WWAN handoff feature.

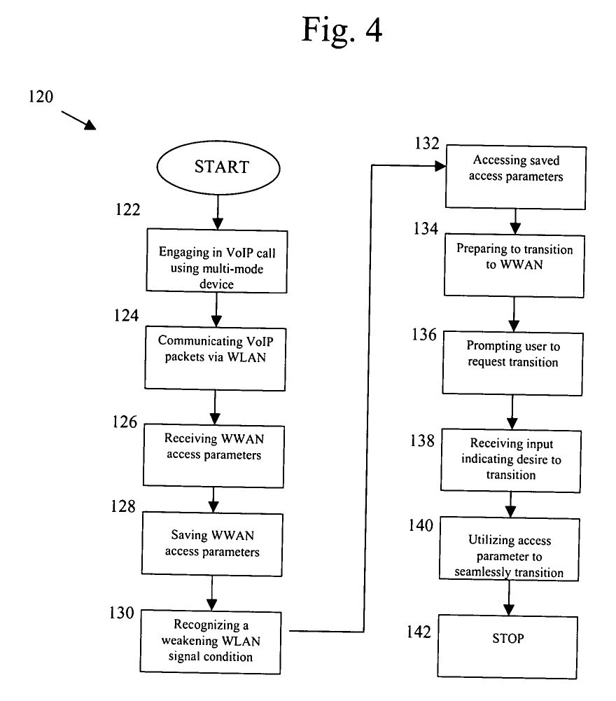

Consideration of FIG. 4 may assist in providing a better understanding of how a user may make use of a system like system 96. FIG. 4 shows a flow diagram for a technique 120 that may be used to implement teachings of the present disclosure. At step 122, a user may be engaging in a VoIP call with a multi-mode terminal device like laptop 98 of FIG. 3. While engaged in the call, VoIP packets may be communicated at step 124 across a given WLAN. While connected to the WLAN, the multi-mode terminal device may receive information that includes WWAN access parameters. This information may be included, for example, in the frame field of a WLAN broadcast packet.

At step 128, the access parameters may be removed form the packet and saved locally to the multi-mode device. In some cases, each of steps 124, 126, and 128 may occur during a VoIP call occurring at least partially across the WLAN. At step 130, a weakening WLAN signal condition may be recognized. At step 132, the saved access parameters may be called, and the multi-mode device may begin preparing to transition from the WLAN to an appropriate WWAN at step 134.

At step 136, a user may be prompted to request network transition. If the user has no intention and/or need to leave the coverage area of the current WLAN, the user may decline to transfer networks. If the user does plan to move away from the current WLAN, the user may elect to transition. In some embodiments, the user may not be prompted and the transition may occur automatically.

At step 138, the user may have elected network transition, and an input indicating this selection may have been received by the multi-mode terminal device. At step 140, the saved access parameters may be utilized to effectuate a seamless transition to an appropriate WWAN and technique 120 may progress to stop at step 142. As with technique 60, technique 120 has been described as having a sequence of steps. Additional steps may be added, steps may be removed, steps may be re-ordered, and/or looped, all without departing from the teachings of the present disclosure. Moreover, the event and/or condition triggering network transition may include things in addition to and/or other than a weakening WLAN signal. The transition may be triggered, for example, by one or more service quality indicators such as Packet Error Rate.

In operation of systems like systems 10 and 96, nodes, servers, modules, agents, platforms, mechanisms, and/or engines may be implemented in several ways. For example, they may include hardware, firmware, software, executable code, and/or a combination thereof. Platforms, which may be implementing nodes, servers, modules, mechanisms, and/or engines, may be made up of a microprocessor, a personal computer, a computer, some other computing device, or a collection thereof. Though nodes, servers, modules, agents, platforms, mechanisms, and/or engines may have been described as individual elements, one or more may be combined and designed to operate as a single element.

In various embodiments, the communication devices described herein may take forms including computers, laptops, desktops, wireless and cordless phones, pagers, personal digital assistants with built in communications circuitries, cellular telephones, mobile telephones, and other electronic devices having processing and network access capabilities.

The methods and systems described herein provide for an adaptable implementation. Although certain embodiments have been described using specific examples, it will be apparent to those skilled in the art that the invention is not limited to these few examples. Additionally, various types of wireless transceivers, transmitters, receivers, and protocols are currently available which could be suitable for use in employing the methods as taught herein. Note also, that although certain illustrative embodiments have been shown and described in detail herein, along with certain variants thereof, many other varied embodiments may be constructed by those skilled in the art.

The benefits, advantages, solutions to problems, and any element(s) that may cause any benefit, advantage, or solution to occur or become more pronounced are not to be construed as a critical, required, or essential feature or element of the present invention. Accordingly, the present invention is not intended to be limited to the specific form set forth herein, but on the contrary, it is intended to cover such alternatives, modifications, and equivalents, as can be reasonably included within the spirit and scope of the invention as provided by the claims below.

1. A communication system comprising:
a wireless local area network (WLAN) base station having a wireless local area transceiver and a wide area network module; and
a handoff facilitation engine operable to access wireless wide area network (WWAN) access information received via the wide area network module and to initiate outputting of a packet via the wireless local area transceiver that comprises at least a portion of the WWAN access information.

2. The system of claim 1, wherein WWAN access information comprises access information and a parameter selected from the group consisting of a WWAN operator identifier, a cell identifier, a channel number, a radio frequency value, a code for a broadcast channel of a Code Division Multiple Access network, a channel descriptor, an access channel control parameter, a neighboring cell identifier, a measuring parameter, and a reporting parameter.

3. The system of claim 1, wherein the wide area network module further comprising a wide area wireless receiver configured to receive a signal communicated from a cellular network node.

4. The system of claim 1, wherein the wide area network module further comprising a wide area wireless transceiver configured to communicate information in a format that complies with a form of an Enhanced Data rate for GSM Evolution.

5. The system of claim 1, wherein the wide area network module further comprising a wide area wireless transceiver that can be configured to communicate information in at least one of a Global System for Mobile Communication format, General Packet Radio Service format, Enhanced Data rate for GSM Evolution format, Universal Mobile Telecommunications Service format, an IS95 format, and a CDMA2000 format.

6. The system of claim 1, wireless local area transceiver is an 802.11(x) compliant device.

7. The system of claim 1, wherein the packet comprises a beacon packet having a frame data field that conveys the at least a portion of the WWAN access information.

8. The system of claim 1, wherein the packet has a frame data field with a variable length no greater than the maximum length defined in the WLAN standards.

9. The system of claim 1, further comprising:
a housing component of the WLAN base station, the housing component at least partially defining an interior cavity; and
a mounting platform located within the interior cavity, the mounting platform securing the wide area network module and the wireless local area transceiver within the interior cavity.

10. The system of claim 9, wherein the handoff facilitation engine is further operable to broadcast the packet and to respond to an inquiry regarding the WWAN access information communicated from the multi-mode terminal device.

11. The system of claim 1, wherein the handoff facilitation engine is further operable to periodically broadcast access information in a broadcast channel of the WLAN.

12. The system of claim 1, further comprising a multi-mode terminal device operable to communicate with the wireless local area transceiver and further operable to communicate with the WWAN.

13. The system of claim 12, wherein the multi-mode terminal device has a from factor selected from the group consisting of a laptop computer, a portable computer, a wireless telephone, a cellular telephone, a smartphone, and a personal digital assistant.

14. The system of claim 1, further comprising a cellular network node operable to output the WWAN access information.

15. A network handoff method comprising:
receiving information comprising a connection parameter for accessing a wide area wireless network (WWAN) node; and
communicating the connection parameter across a wireless local area network (WLAN).

16. The method of claim 15, further comprising:
generating a packet that includes the connection parameter in a frame data field; and
passing the packet to a WLAN transceiver for communication across the WLAN.

17. The method of claim 15, wherein communicating the connection parameter comprises broadcasting a packet containing the connection parameter in a broadcast channel of the WLAN.

18. The method of claim 15, wherein communicating the connection parameters comprises sending a packet containing the connection parameters to the multi-mode terminal device in response to an inquiry from the terminal device

19. The method of claim 15, further comprising listening for the connection parameter with a cellular receiver.

20. The method of claim 15, further comprising listening for multiple carrier-specific access parameters.

21. The method of claim 15, further comprising:
communicating with an electronic device via the WLAN;
determining that the electronic device comprises WLAN and WWAN connection capabilities; and
communicating the connection parameter to the electronic device.

22. The method of claim 15, further comprising:
receiving a new WWAN connection parameter; and
communicating the new WWAN connection parameter across the WLAN.

23. The method of claim 15, further comprising receiving the information comprising the connection parameter with a wide area wireless receiver.

24. The method of claim 15, further comprising receiving the information comprising the connection parameter via a broadband connection to a wireline network.

25. The method of claim 15, further comprising:
receiving the information comprising the connection parameter with a wide area wireless receiver, the information having a format conducive for communication via the WWAN; and
reformatting the information for communication via the WLAN.

26. The method of claim 25, wherein the format allows for communication via a Global System for Mobile (GSM) communication network, further wherein the WLAN is an 802.11(x) WLAN.

27. A network handoff method comprising:
interacting with a wireless local area network (WLAN) hub; and
receiving a packet from the WLAN hub, the packet comprising access information that includes an access parameter for interacting with a node of a wide area wireless network (WWAN).

28. The method of claim 27, wherein the WLAN hub received the access parameter via a link selected from a group consisting of a GSM link, Global Packet Radio Services (GPRS) link, an Enhanced rate for Data GSM Evolution (EDGE) link, an IS-136 link, an IS-95 link, an UMTS link, a CDMA2000 link, an iDEN link, a cable modem link, a satellite link, and a Digital Subscriber Line (DSL) link.

29. The method of claim 27, further comprising locally storing the access parameter.

30. The method of claim 27, further comprising:
recognizing a weakening state of a connection with the WLAN hub; and
utilizing the access parameter to transition to a wide area wireless connection with the node of the WWAN.

31. The method of claim 27, further comprising:
engaging in an active communication session with a remote device via the WLAN hub; and
transitioning to the wide area wireless connection with the node of the WWAN without dropping the active communication session.

32. The method of claim 31, wherein the active communication session is selected from a group consisting of a circuit-switched voice session, a circuit-switched data session, a packet-switched data session, and a Voice over Internet Protocol call.

33. A network handoff system, comprising:
an electronic device having a computing platform, a wireless local area network (WLAN) transceiver, and a wireless wide area network (WWAN) transceiver;
a housing component of the electronic device, the housing component at least partially defining an interior cavity;
an interior surface of the electronic device, the interior surface maintaining the computing platform, the WLAN transceiver, and the WWAN transceiver in respective locations within the interior cavity; and
a handoff engine operable to execute on the computing platform and to allow the electronic device to process an access packet received via the WLAN transceiver, the access packet comprising access information that includes an access parameter for interacting with a node of a wide area wireless network WWAN, and to use the access parameter to transition the electronic device from a WLAN connection to a WWAN connection.

34. The system of claim 33, wherein the transition occurs without performance of a WWAN monitoring procedure to acquire the WWAN access parameter.

35. The system of claim 33, wherein the transition occurs without dropping an active communication session between the electronic device and a remote device.

36. The system of claim 33, wherein the transition occurs automatically if a signal strength of a WLAN connection approaches a low threshold value.

37. The system of claim 33, wherein the transition occurs in response to an input by a user of the electronic device.
